(19) United States
(12) Patent Application Publication
(10) Pub. No.: US 2005/0225572 A1
(43) Pub. Date: Oct. 13, 2005

(54) Versatile user interface

(76) Inventor: Frank Edughom Ekpar, Fukui City (JP)

Correspondence Address: FRANK EDUGHOM EKPAR, DAIANJI DANCHI 3-202, MINAMI NARAHARACHO 20-15-5, FUKUI CITY, 910-0046, JP

(21) Appl. No.: 11/097,879

(22) Filed: Apr. 4, 2005

Related U.S. Application Data
(60) Provisional application No. 60/559,939, filed on Apr. 3, 2004.

(51) Int. Cl. G09G 5/00

(52) U.S. Cl. 345/660

(57) ABSTRACT

The present invention discloses a versatile graphical user interface comprising one or more N-dimensional background elements each of which is divided into one or more arbitrarily-shaped N-dimensional partitions, wherein each partition may contain one or more user interface elements and is associated with one or more sets of rules that define rendering, positioning, element placement and other relevant attributes and behaviors, wherein said rules can be specified in such a way as to enable said N-dimensional background to assume any desired arbitrary shape and to facilitate expansion to any desired arbitrary size without distortion or loss in quality.

### CROSS-REFERENCE TO RELATED APPLICATIONS

This U.S. Non-Provisional Application claims the benefit of U.S. Provisional Application Ser. No. 60/559,939, filed on Apr. 3, 2004, herein incorporated by reference.

### BACKGROUND OF THE INVENTION

1. Field of the Invention

The present invention relates generally to the field of graphical user interfaces. In particular, the invention relates to a graphical user interface system permitting the creation of rich multi-dimensional graphical user interfaces that can have any shape and that can dynamically be expanded to any size without distortion or loss in quality.

2. Description of the Prior Art

Contemporary graphical user interfaces are limited in that when they allow arbitrary shapes, they are generally not expandable and when they are expandable, they generally do not permit the use of arbitrary shapes. Furthermore, these graphical user interfaces are generally limited to flat 2-dimensional or at best simulated 3-dimensional structures. Popular graphical user interface systems from software developers such as Microsoft and Apple suffer from these limitations.

### SUMMARY OF THE INVENTION

It is an object of the present invention to overcome the limitations of the prior art set forth above by providing a versatile graphical user interface comprising one or more N-dimensional background elements each of which is divided into one or more arbitrarily-shaped N-dimensional partitions, wherein each partition is associated with one or more sets of rendering, positioning, element placement and other relevant rules and may contain one or more user interface elements—thus enabling said N-dimensional background to assume any desired arbitrary shape and to facilitate expansion to any desired arbitrary size without distortion or loss in quality. This leads to much more versatile, more dynamic and richer user interfaces than are possible with the prior art.

### BRIEF DESCRIPTION OF THE DRAWINGS

FIG. 1 illustrates a preferred embodiment of the present invention.

### DETAILED DESCRIPTION OF THE PREFERRED EMBODIMENTS

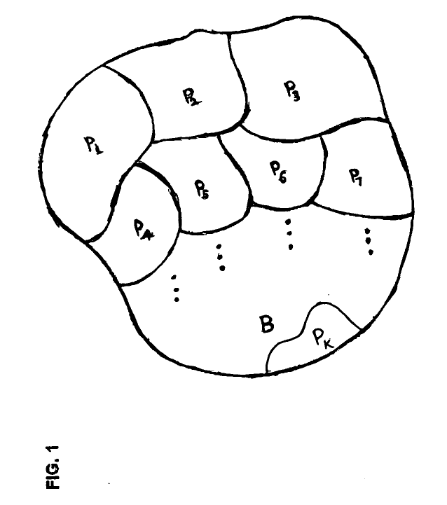

Referring now to FIG. 1, an illustration of a preferred embodiment of the present invention, the arbitrarily-sized and arbitrarily-shaped background is indicated generally as B. In FIG. 1, P₁, P₂, P₃, P₄, P₅, P₆, P₇, . . . , P_{K} are partitions. K can be any number. For simplicity, the background and partitions in FIG. 1 are 2-dimensional. Furthermore, the partitions are contiguous. In practice, however, the background and partitions are N-dimensional (where N can be 1, 2, 3, 4—for 3 spatial dimensions and 1 temporal dimension for instance, 5, or any number of dimensions) and the partitions need not be contiguous. Each partition may contain any number of user interface elements. According to the principles of the present invention, each partition has an arbitrary shape and an arbitrary size and is associated with a set of rules that define rendering, positioning, element placement and other relevant behaviors and attributes. These rules can be specified in such a way that the N-dimensional background-based graphical user interface can assume any arbitrary desired shape and can be expanded to any arbitrary desired size without distortion or loss in quality. For instance, if the background comprises a single, arbitrarily-shaped digital image and the user interface built from said background is to be rendered on a computer screen, then said background can be divided into a number of partitions based on the nature of the background and the rendering of each partition can in turn be carried out on the basis of the nature of the partition. A partition defined on a uniformly textured region of the background can be stretched without noticeable distortion or loss in quality. In contrast, a partition defined on a non-uniform region of the background may be rendered in its original size and shape to prevent distortion and loss in quality. By creating a number of partitions based on the nature of the background and selectively assigning appropriate sets of rules for rendering, positioning, component placement and other behaviors and attributes of each partition, the entire background can be made to assume an arbitrary shape and an arbitrary size without distortion or loss in quality. Consequently, user interfaces based on the principles of the present invention are more versatile, more dynamic and allow a much richer user experience than is possible with the prior art.

It should be understood that numerous alternative embodiments and equivalents of the invention described herein may be employed in practicing the invention. Thus, it is intended that the appended claims define the scope of the invention and that methods and structures within the scope of these claims and their equivalents be covered thereby.

1. A graphical user interface, said graphical user interface comprising:
one or more arbitrarily-sized and arbitrarily-shaped N-dimensional background elements each of which is divided into one or more arbitrarily-sized and arbitrarily-shaped N-dimensional partitions, wherein each partition may contain user interface elements and is associated with one or more sets of rules that define rendering, positioning, element placement and other relevant attributes and behaviors, wherein said rules can be specified in such a way that said background can assume any desired arbitrary shape and can be expanded to any desired arbitrary size without distortion or loss in quality.
